(19) United States
(12) Patent Application Publication
(10) Pub. No.: US 2006/0080336 A1
(43) Pub. Date: Apr. 13, 2006

(54) Encapsulation and unified access scheme for components

(75) Inventors: Yaoxue Zhang, Beijing (CN); Cunhao Fang, Beijing (CN); Bo Liu, Beijing (CN); Yuezhi Zhou, Beijing (CN); Guanfei Guo, Beijing (CN); Li Wei, Beijing (CN); Pengzhi Xu, Beijing (CN)

Correspondence Address: BINGHAM, MCCUTCHEN LLP, THREE EMBARCADERO CENTER, 18 FLOOR, SAN FRANCISCO, CA, 94111-4067, US

(73) Assignee: TSINGHUA UNIVERSITY, Beijing (CN)

(21) Appl. No.: 11/096,437

(22) Filed: Mar. 31, 2005

(30) Foreign Application Priority Data
Apr. 2, 2004 (CN) 200410030654.5

(51) Int. Cl. G06F 7/00

(52) U.S. Cl. 707/100

(57) ABSTRACT

A method is provided for encapsulating and accessing components, comprising: configurating component warehouse and storing components acquired from the Internet into the component warehouse to form a component warehouse computer; configurating a component directory library on another computer to form a component directory library computer; fetching component from the component computer by a user computer, encapsulating the component to form a encapsulated component, and organizing and storing the encapsulated component in the component directory library computer; and performing unified access to component resources by a user computer based on the component encapsulation information in the component directory library computer. The method can implement unified description and efficient organization of the existing component resources, to thereby support efficient retrieval and unified access to the component resources by high level applications. The method can also improve the reuse of network software and the efficiency of software development in many application fields.

### TECHNICAL FIELD

The present invention relates to the technical field of software engineering and particularly relates to improvement of the versatility of software components.

### BACKGROUND ART

Recently, the integration of service flow and the automation level in the application fields of finance, education, electronic commerce, electronic government, medical care, health and so on have been greatly promoted and enhanced by software systems, as an implementing way of the concrete technical solution, together with computer hardware, I/O devices and computer network infrastructure. In those application fields, software becomes an important part of the technical solution and plays an important role in the implementation of the functionalities in those application fields.

As the tasks required to be fulfilled by software become more complicated and the demands on functionality become more competitive, the tasks of software development are more and more arduous accordingly. At the same time, as the functionality of software becomes more powerful, the problem of repeated development of many functions has arisen as well. Therefore, it has been suggested that the common parts in the software systems can be made as separate software components to be repeatedly used in different software systems, thus the cost of development can be reduced and the reliability and security of the software system can be enhanced. This is referred to as software reuse technology.

At the same time, as the application of Internet is extended, Internet has evolved from a simple information issuing platform into a distributed computing platform. Not only information but also various network application programs (services) can be obtained from the Internet. The personalized customizing applications for end users oriented will be one of the major schemes of software development in the future. Thus a scheme is needed to implement an integration of those reusable components by employing the reusable software components distributed over the network and the unified access to those software components, whereby new soft wares (services) satisfying the requirements can be developed.

Software reuse is a solution to avoid repetitive work in software development, the origination thereof is that the development of an application system does not employ the scheme of every thing “starting from null”, but based on existing results and exploiting as much as possible the existing knowledge and experiences collected in the development of application systems, for example demand analysis results, designs, source code, debugging modes, and debugging cases, thereby the focus of development can be concentrated on the specific parts of the application.

The key factors (technical and non-technical factors) for implementing software reuse principally comprise: software component technology, domain engineering, software architecture, software reengineering, open engineering, software process, CASE technology, etc and various non-technical factors. These factors are mutually related and mutually affected; the combination of them impacts collectively the implementation of software reuse.

Wherein, the component technology is a kernel technology for supporting software reuse. In the specification of the present invention, a component refers to a software module having relatively independent function and reusable value.

Component technology is a revolution in the procedure of traditional software development. Components have similar roles in software designs with integrated circuit (IC) modules in electronic designs. They conceal concrete realization of functions and provide strictly defined interfaces to the outside. Therefore, components are aptly called “software ICs”(FIG. 1). They are software modules having independent functions and reusable value, and have following features:
(1) independently published software module;
(2) encapsulation of specific functions through strictly defined interfaces;
(3) supporting plug-and-play in the component framework;
(4) supporting collaboration and composition with other components to form a software system;
(5) being capable of being replaced by other components that implement the same interface.

To support software reusable technology, many organizations and companies successively put forward their own component standards. At present, the most influential component standards include Sun's Java component standard JavaBean/EJB, Microsoft's standard COM/DCOM and Object Management Group (OMG)'s CCM standard in CORBA 3.0. They are introduced here briefly:
(1) JavaBean. JavaBean is a Java-based component technology specification released by Sun Microsystems in September 1996. It integrates component technologies with the Java language. On the basis of this specification, the developers can make Java components independent of operating system platforms.
(2) EJB (Enterprise Java Bean). EJB was published by Sun Microsystems in March 1998. It defines the server-side component interfaces of development, configuration, and management, and allows the user to reuse the server-side components to develop large-scale business applications. At present, a lot of companies, including Oracle, Borland, Tandem, Symantec, and Sybase, have declared their support for EJB in their respective products.
(3) CORBA Component Model (CCM). CCM was voted and passed by relevant work groups of the Object Management Organization in August 1999. It is an important part of the CORBA 3.0 Specification, which defines the component framework for creating, composing, and publishing of plug-and-play CORBA objects.
(4) COM/DCOM. COM/DCOM is a component specification put forward by Microsoft, which is a binary standard, and neither designates the component implementation language nor restricts component realization methods. It aims at improving the efficiency and security of remote component access with the provision of the optimized remote calling mechanism and authorized accessing mechanism.

Conforming to the standards of the component mentioned above, people have developed a lot of components and set up professional component libraries on the Internet as reusable resources, such as Alphaworks, Component planet, Component Source, Flashline and etc., have appeared on the Internet, which have provided many existing usable components and form component resources on the Internet. They have provided a basis for software reuse and component based program development. The scales of network component libraries are steadily increasing with the development of component technology, so as to provide a concrete basis for component based software development and provide component resources for the combination of application and service.

However, various kinds of components are being developed by the use of specific specifications of themselves, the component descriptions lack necessary support for unified access between different kinds of components, which results in difficulty in the choosing, searching, retrieving, analyzing, and composing of components in software reuse, caused by differences in description, structure organization, and access manner of these component resources. The following are two main drawbacks thereof:
1) The external information of component description is insufficient, so that what the component can do is not clearly and consistently described. The existing component description languages are unable to provide sufficient information on component organization resource and function classification, the descriptions of the capabilities of the components are insufficient and inconsistent, making higher level application difficult to search and acquire components;
2) The behavior information of component interfaces is inconsistent, thus “how to use the component” can not be specified clearly and consistently, the behavior of a component is indicated by the interfaces thereof. Recently, the description of interfaces of each of the various kinds of components is severely dependent on the programming language implementing the component, thus making the description inconsistent and unable to support mutual access between components. At present, in order to carry out unified access between two components belonging to different component models respectively, a special conversion intermediator must be added between the components to exchange information. For example, the following steps are necessary to implement unified access between JavaBean components and CORBA components:
(1) Generating a description conversion intermediator for JavaBean-to-CORBA;
(2) Generating a description conversion intermediator for CORBA-to-JavaBean;
(3) By the JavaBean-to-CORBA intermediator, converting the access information issued by the JavaBean component into information which can be understood by the CORBA component;
(4) The CORBA component receives and responds to these information, sends the reply answer message to the CORBA-to-JavaBean intermediator, the intermediator then converts the information into identifiable information by JavaBean component;
(5) The JavaBean component receives these information and the ends the access.

Similarly, if a JavaBeans component is expected to interact with an Active X component, a JavaBeans-Active X description conversion intermediate and an Active X-JavaBeans description conversion intermediate are also needed to complete mutual accesses following the above mentioned stops. Thus the data exchange and data sharing between different component models become very complicated and hard to realize. Because implementing scheme of each kind of the component models are different, therefore, communication between each pair of two different component models is required to use a specific description conversion intermediates which are dedicated to specific kinds of components rather than versatile ones. Processing the interactions required by the cooperation among n components by use of this scheme requires a number of description conversion intermediates in the order of n(n−1). The amount of work required is huge and the efficiency is not high. Therefore, this scheme is unable to thoroughly resolve the problem of implementing transparent unified access between different components.

### SUMMARY OF THE INVENTION

It is an object of the present invention to overcome the drawbacks of the prior art and to propose an encapsulation and unified access method for components: On the basis of various existing component model (e.g. ActiveX, JavaBean, EJB, and etc), a versatile component encapsulation structure is proposed, which is called UCDL(Unified component Description Language) encapsulation structure in the present invention. This structure masks the differences between the component descriptions and invoking interfaces of different types of components to thereby implement unified access to components. Based thereon, unified description and efficient organization of the existing component resources on the Internet can be realized; therefore, efficient retrieval and unified access to the component resource by the higher level application can be better supported. The present invention may enhance the efficiency of software reuse and software development in the application fields of finance, education, electronic commerce, electronic government, medical care and health, etc.

The present invention provides an encapsulation and unified access method for components.

The method mainly comprises following steps:
Step 1, setting a component warehouse on one or more computers, and storing components obtained from the Internet in the component library to constitute a component warehouse computer;
Step 2, setting a component directory library on another computer to constitute a component directory library computer, which will be used to store these encapsulated components and its index information;
Step 3, fetching components from the component warehouse computer by a user computer, encapsulating the components to form encapsulated components, organizing and storing them in the component directory library computer;
Step 4, implementing the unified access to the component resources according to those encapsulated component information and their index structure in the component directory library computer.

The encapsulation scheme of the components stated in Step 3 comprises following sub-steps:
(1) Constructing a general encapsulation structure. This structure comprises a static information part and a dynamic information part described in an unified form, wherein the static information part comprises basic description information, resource location information, classification information (e.g. component name, author, Vendor, version, date, size, functional description, etc.) of the component; the dynamic component information part is the component interface information comprising interface information provided by the component and interface information required for running of the component;
(2) fetching a component from the existing component warehouse, determining the type of the component to be encapsulated based on the file extension name and the inherent identification field of the component, for example, a JavaBean component, ActiveX component or other types of component.
(3) After the determination of the component type, for different component types, fetching the information on the component per se, and filling the information on the component per se into respective portions of the encapsulation structure (first, obtaining the static information of the component based on the basic information fields in the description of the component per se, and filling the static information into the static information portion of the encapsulation structure; then fetching the dynamic interface information of the component per se, and filling it into the dynamic information portion of the encapsulation structure), finally, forming a UCDL encapsulated component of the information on the component per se described in an unified form;

The encapsulated component is in fact a component information description file in the form of XML file and generated based on the encapsulation structure, which is called UCDL encapsulated component;
(4) Organizing and storing the UCDL encapsulated component generated in step (3) into the component directory library according to the classification information therein (that is, registering the encapsulated component into the directory library), creating a general index structure for all UCDL encapsulated components in the directory library according to the classification information, wherein each of the directory entries in the library is the encapsulated component; while the component entity per se is still stored in the original component warehouse.

The unified access to the component based on component encapsulation mentioned in the above Step 4 comprises the following steps:
(1) According to the classification information and basic description information in the UCDL encapsulation structure, inquiring a group of encapsulated components conforming to the conditions from the directory library by a component user;
(2) According to the interface information in the UCDL encapsulation structures, further finding the component with fully matched interfaces;
(3) Fetching the required component entity per se from the component warehouse based on the location information in the encapsulation structure;
(4) Realizing mutual invoking of components between a component user and the component entity, according to the interface information defined in the UCDL encapsulation structure, in combination with the existing component binding protocol (e.g. SOAP: Simple Object Access Protocol).

According to another aspect of the present invention, a method of collecting, encapsulating and accessing components on a network is provided, comprising:
Step 1, searching for components on the network based on component identification, and storing the acquired components in a component warehouse to form a component warehouse computer;
Step 2, constructing a general component encapsulation structure for each of the components in the component warehouse. This structure comprises a static information part and a dynamic information part described in an unified form, wherein the static information part comprises basic description information, resource location information, classification information; and the dynamic information part comprises interface information provided by the component and interface information required for running of the component
Step 3, fetching the component from the existing component warehouse, and generating classification information of the component to be encapsulated based on the unified classification specification and the internal classification information field of the component;
Step 4, fetching the information on the component per se and its location information in the component warehouse for the components in the component library having formed their classification information, and filling the information into the corresponding portions of its component encapsulation structure according to corresponding format and based on corresponding mapping method, i.e., instancing the encapsulated component;
Step 5, corresponding to each of the instanced encapsulated components in the component library, registering the encapsulated component into a directory library according to the information in the classification information portion in the encapsulated component, wherein the component directory library maintains a general index structure and indexes into all registered encapsulated components;
Step 6, issuing the index structure in the directory library and corresponding searching tools on the network;
Step 7, searching the index structure of the directory library by use of classification information and description information input by the component user, and acquiring a group of encapsulated components in conformity with the search information;
Step 8, finding, by the component user, an encapsulated component whose interface information fully matches the required interface from the group of encapsulated components as the result of component searching;
Step 9, acquiring or invoking, by the component user, the component corresponding to the encapsulated component from the component library, based on the location information in the found encapsulated component. Wherein, the network refers to the Internet, and the description information associated with the component is stored together with the component when searching the components. At the same time, the component library administrator may manually modify the instanced encapsulated components and their registration information in the component directory library with reference to the description information associated with the components.

The present invention provides a unified encapsulation structure for all components, which is called UCDL (Universal Component Description Language) encapsulation structure. In the UCDL encapsulation structure, “What a component can do” and “how a component is used” are indicated by a unified terminology space, and these information are expressed by the use of XML to facilitate the interaction and processing of the behavior information between components, and to facilitate unified access to various different types of component resources by higher level applications. The data exchange and data sharing between components of different component models become data exchange and data sharing between UCDL encapsulated components. The UCDL encapsulated components implement the unified description and efficient organization of the existing component resources on the basis of the insurance of the capability of mutual understanding between different types of components. Unified access between different types of component resources and higher level applications can be performed via the access interfaces of the UCDL encapsulators of the components.

According to the method of the present invention, unified access between different components can be implemented by the encapsulation of components. For the client programs which require to access different types of components meanwhile, not only the programs at the client side can be greatly simplified, but also the flexibility of software integration can be enhanced.

The present invention may be applied to the application fields of finance, education, electronic commerce, electronic government, medical care and health, and etc. With respect to various components of different models and different providers in those fields, UCDL capsulated components can be generated by the use of the universal component description method of the present invention, and component library of the field can be organized uniformly to implement unified access to component resources, thereby the formation and dynamic adjustment of the service flow of the application fields can be supported flexibly, as well as the user-oriented personalized application customizing and integration can be supported.

According to the present invention, not only the efficiency of further development of the component platform and the component (program) digging system by software designers can be enhanced, but also the applications required by users can be found and customized based on the requirement of end users, so as to provide unified component access interfaces for future active service oriented to the user.

According to the present invention, component search engines similar to Web search engines(such as Yahoo, Google and etc), can be provided for users, and by developing corresponding access interfaces, the indexing and retrieval for components can be provided to support software reuse in the Internet environment.

According to the present invention, the security of a software system can be enhanced. User may employ the technology of unified access for components according to the present invention at any time on the basis of the requirements of network environment and application security, and use optional components to flexibly replace the security components and their assembling scheme used by the software system. For example, important effects can be attained in the security and protection of finance, electronic government and other fields.

### BRIEF DESCRIPTION OF FIGURES

FIG. 1 is a schematic diagram showing a structure of the component structure;

FIG. 2 is a schematic diagram showing the flow chart of the method of the present invention;

FIG. 3 shows the steps of the component encapsulation method of the present invention;

FIG. 4 shows the steps of the unified access method for components according to the present invention;

FIG. 5 is the schematic diagram of the structure of the UCDL encapsulated component according to the present invention; and

FIG. 6 is a schematic diagram showing a tree directory index structure in the component directory library according to the present invention.

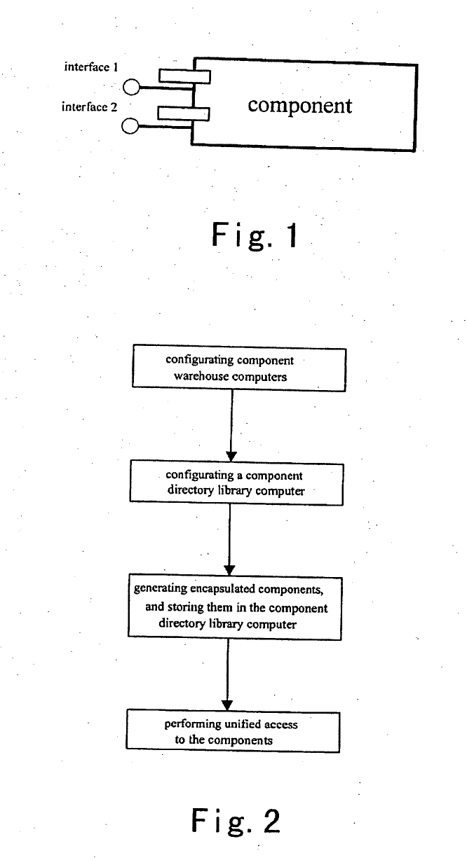

### MODE OF CARRYING OUT THE INVENTION

An encapsulation and unified access method for components proposed by the present invention will be described in detail in combination with the accompanying figures and embodiments in the following.

The present invention provides an encapsulation and unified access method for components, as shown in FIG. 2. The method comprises following steps:
Step 1, setting a component warehouse on one or more computers, and storing components obtained from the Internet in the component warehouse to constitute a component warehouse computer;
Step 2, setting a component directory library on another computer to constitute a component directory library computer; which will be used to store those encapsulated components and their index information;
Step 3, fetching components from the component warehouse computer, encapsulating the components to form encapsulated components, organizing and storing them in the component directory library computer;
Step 4, the user computer performs unified access to the component resources based on the encapsulated component information in the component directory library computer.

The steps will be described later in more detail.

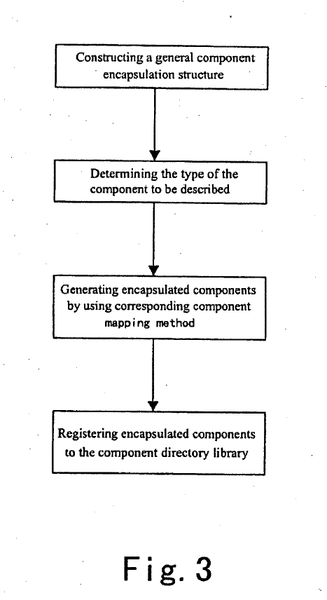

As shown in FIG. 3, the above mentioned component encapsulation method comprises following sub-steps:

Sub-Step 1 of the Component Encapsulation Method:

Constructing a general component encapsulation structure; actually, the encapsulated component is a component information description file in the form of XML file generated according to this structure, which is called UCDL (Unified Component Description Language) encapsulated component in the present invention.

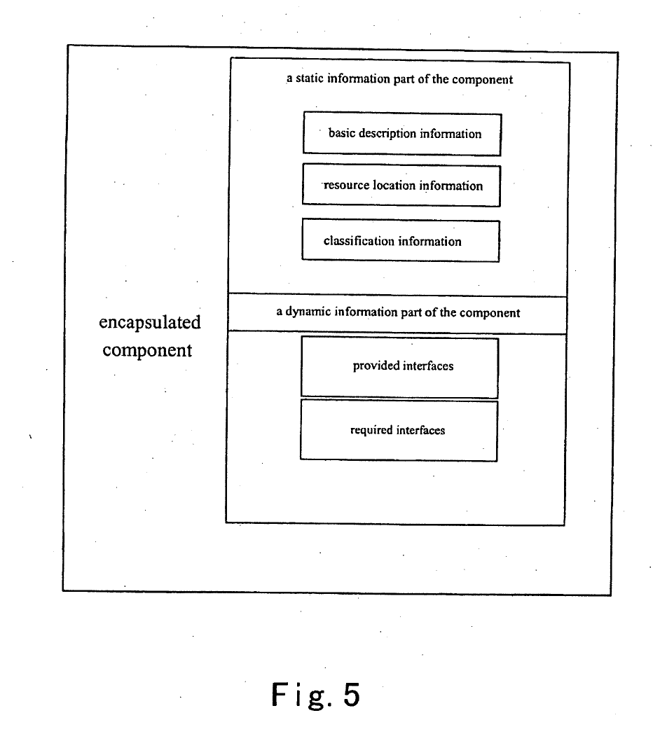

The UCDL encapsulation structure according to the present invention has the structure shown in FIG. 5, and comprises four portions: basic description information, resource location information, classification information and component interface information, wherein basic description information, resource location information and classification information belong to a static information part; while the component interface information is a dynamic information part of the component, and is further subdivided into interface information provided by the component and interface information used by the component. Each of the portions and their corresponding descriptors and meanings are shown in Table 1.

TABLE 1

| Information Type | | Descriptor | | Meaning of Descriptor | |
|---|---|---|---|---|---|
| Static | Basic | ID | | Globally unique identification of the | |
| component | description | | | component descriptor | |
| information | information | Name | | The name of the component | |
| | | Author | | The author creating the component, | |
| | | | | including the name, address and contact | |
| | | | | information of the author | |
| | | Vendor | | The manufacturer or organization | |
| | | | | providing the component, including the | |
| | | | | name, address, contact information of the | |
| | | | | corporation and etc | |
| | | Version | | The current version and revised edition | |
| | | | | number of the component | |
| | | Functional Description | | Literal description of the functions | |
| | | | | performed by the component, indicting the | |
| | | | | main features, functions and other | |
| | | | | information of the component required to | |
| | | | | be described, a keyword list can be | |
| | | | | extracted from the description to support | |
| | | | | traditional component retrieval based on | |
| | | | | keyword matching, | |
| | | Date | | Date of issuance and being indexed of the | |
| | | | | component | |
| | | Size | | Size of the component in k bytes | |
| | classification | Component Model | | The standard frame for providing service | |
| | information | | | or interface for running and operating of | |
| | | | | the component | |
| | | Program Language | | The programming language used to | |
| | | | | implement the component | |
| | | Application Field | | Specific field of actual application of the | |
| | | | | component, e.g., finance, commerce, | |
| | | | | medical care, and etc. | |
| | | Operation System | | The operating system platform supported | |
| | | | | by the component | |
| | | Component Function | | The active processes in the software | |
| | | | | development. The specific functions of the | |
| | | | | component are divided into a plurality of | |
| | | | | subclasses. | |
| | Resource | Location | | The location of the executable portion of | |
| | location | | | the component, generally indicated by | |
| | information | | | URL | |
| Dynamic | Provided | Provided Interface list | | The services provided by the component, a | |
| information | interface | | | component may have one or more | |
| | information | | | interfaces | |
| | | Provided | Name | Name of operation | |
| | | Interface | Description | Functional description of the operation | |
| | | Description | Parameters | Entry and exit parameters of the operation | |
| | | | Name | The names of parameters of operation | |
| | | | Type | The types of parameters | |
| | | | Description | Description of the parameters | |
| | | | Invariants | The constraint conditions of the parameter | |
| | | | Return | Return value of the operation | |
| | | | Value | | |
| | | | Constraints | Constraints of the operation behaviour, if | |
| | | | | the pre-condition is satisfied, then the | |
| | | | | post-condition is guaranteed to be satisfied | |
| | | | | after completion of the operation | |
| | | | Pre- | Pre-condition | |
| | | | condition | | |
| | | | Post- | Post-condition | |
| | | | condition | | |
| | | | Event List | A list of events issued by the component | |
| | | | Event | Name | Names of events |
| | | | Description | Description | Description of events |
| | | | | Listening | The Listening Method of |
| | | | | Method | the event |
| | | | | Event | The object passed by the |
| | | | | Object | event. |
| | | | Properties | The properties presented to the external | |
| | | | | by the component | |
| | | | Property | Name | Name of the property |
| | | | Description | Type | Type of the property |
| | | | | Description | Description of the property |
| | | | | Default | Default value of the |
| | | | | Value | property |
| | | | | Valid Value | Valid value |
| | | | | Access | Access method of the |
| | | | | Methods | property |
| | Information | Required Interface list | | Services required to be provided by the | |
| | of required | | | external for the normal running of the | |
| | interface | | | component | |
| | | Required | Component | indicating a list of components directly | |
| | | Interface | list | providing services to the component | |
| | | | Service List | indicating the specific service required | |
| | | | | by normal running of the component | |
| | | | Service | Name | Name of service |
| | | | Description | Type | Type of service |
| | | | | Description | Description of the required |
| | | | | | service |
| | | | | Operation | A list of executable |
| | | | | List | operations providing the |
| | | | | | services |
| | | | | Event List | A list of events required to |
| | | | | | be listened during the |
| | | | | | running of the component |

The description information of the existing components may be converted into corresponding descriptors based on the meanings of the descriptors in the above table, a concrete content of the table is described as follows:

Basic description information: This part indicates nonbehavior features of components defined by component developers (such as component name, author, version, manufacturer, and scale size). In this part, new descriptors may be added to correspond to newly added information on components if necessary, thus extendibility and flexibility of the descriptors can be guaranteed.

Classification information: This part illustrates the information that is used for classifying component resources. UCDL specification classifies components from the viewpoint of component model, application field, programming language, operating system and component function.the classification information in the encapsulation structure corresponds to classification information on the component, in respect of the component model, application field, programming language, operating system and component function. Each of the classification information descriptors comprises a set of basic terms. Each component shall select one or more terms from the set of basic terms as the description of this entry. An embodiment of the set of basic terms of the present invention is shown in Table 2.

TABLE 2
a set of Basic terms of classification information

| classification | Term list | Description |
|---|---|---|
| Component | COM, DCOM, CORBA, EJB, JAVABEAN, | Standard frame for |
| model | Other | providing services or |
| | | interfaces for running and |
| | | operating of the component |
| Programming | C, C++, Csharp, Pascal □ VisualBasic, | Programming |
| language | Fortran□Java□Ada, Assembly, Delphi, Prolog, | language employed to |
| | Lisp, Perl, Other | implement the component |
| Application | Agriculture, Aerospace, Automotive, | The field of |
| Field | Banking, BioTech, Business, Communication, | application of the |
| | Construction, DotCom, Financial, Insurance, | component is the specific |
| | Healthcare, Manufacturing, Real, Estate, Retail, | commercial field of actual |
| | Public, Administration, Services, Software | application of the |
| | Development, Telecommunication, | component, e.g. finance, |
| | Transportation, Utilities, WholesaleTrade, Other | commerce, medical care, |
| | | and etc |
| Operating | Solaris, Linux, HPUX, MacOS, Wintel, | Operating system |
| system | Windows NT, | platform supported by the |
| | Win2000, Other | component |
| Component | Development, Tools, File, Manipulation, | The effective |
| Function | Multimedia, Network, Tools, Scientific | processes in software |
| | Computing, User Interface, Word Processing, | development, the specific |
| | Internet/Intranet, Database, Miscellaneous, | functions of the component |
| | Others | are divided into a plurality |
| | | of subtypes. |

The entry “Component Function” in the above table can be further extended to make the description of the functions of the component more detailed. An embodiment of the term set of the sub-function entry of component according to the present invention is shown in Table 3.

TABLE 3
Term set of sub-function entries of components

| Classification | Term list | Description |
|---|---|---|
| Development Tools | Application Servers | Application servers |
| | Component Managers | Component managers |
| | Component Creation Tools | Component |
| | | generators |
| | Code Components | Code generation |
| | Configuration & Initialization | Configuration and |
| | Components | initialization |
| | Debugging & Testing Components | Tracking and testing |
| | Installation Tools | Installation tools |
| | Localization Components | Localization tools |
| | Source Code Generators | Source code generating |
| | | component |
| | Software Upgrade Components | Software upgrading |
| | Help Components | Help components |
| | Version Control Components | Version control |
| | Software Licensing Components | Software registration |
| | Others | others |
| File Manipulation | Compression | compression |
| | Encryption | encryption |
| | Convert Tools | Conversion tools |
| | File Split Tools | File splitting |
| | Icon Tools | Icon Tools |
| | File Upload Components | File uploading |
| | Imaging Components | Imaging components |
| | PDF Tools | PDF Tools |
| | Others | others |
| Multimedia | Audio, MIDI & Sound Components | sound |
| | Speech Recognition Components | Speech recognition |
| | DirectX Components | DirectX components |
| | MP3 Components | MP3 components |
| | Video Components | video components |
| | QoS Components | Quality of Service |
| | | Control |
| | Multimedia Mail | Multimedia mail |
| | Collaborative | collaborating |
| | | components |
| | Video Conferencing | video conferencing |
| | 3D Modeling Components | 3D modeling |
| Network Tools | Proxy | proxy servers |
| | News | news |
| | Firewall | firewall |
| | Facsimile Components | facsimile components |
| | Directory Service | directory service |
| | Network Management | network management |
| | Network Communication | network communication |
| | Messaging Components | Messaging components |
| | Serial Communication Components | Serial communication |
| | Servlet | Servlet |
| | CGI | common gateway |
| | | interface |
| | Dialup Components | dialup components |
| | BBS | Bulletin board system |
| | Chatting Tools | chatting tools |
| | Others | Others |
| Scientific Computing | Signal Processing | signal processing |
| | Maths & Stats Components | Maths & Stats |
| | | Components |
| | Algorithms | Algorithms |
| | Others | others |
| User Interface | Button Components | Button Components |
| | Calendars/Scheduling | Calendars/Scheduling |
| | Charts/Graphs | Charts/Graphs |
| | Data Input/Masking | Data Input/Masking |
| | Data Entry Verification | Data Entry Verification |
| | Grids/Tables | Tables |
| | Instrumentation | Visual Instrument |
| | | components |
| | Text Components | Text |
| | Tree view & List Components | Tree view/list |
| | Toolbar Components | toolbar |
| | Menu Components | Menu |
| | Diagramming Components | Diagram/curve |
| | | components |
| | Others | others |
| Word Processing | Find & Replace Components | Find/replace |
| | Spelling Components | spelling |
| | Spreadsheet Components | Spreadsheet Components |
| | Print & Preview Components | Print/preview |
| | Reporting Components | reporting |
| | Others | others |
| Internet/Intranet | E-Commerce | Electronic commerce |
| | E-mail | E-mail |
| | FTP | File transmitting |
| | Telnet | Telnet |
| | HTTP | Hyper Text Transport |
| | Security | Security |
| | Website Components | Website |
| | HTML | Hyper Text Markup |
| | | Language |
| | XML | Extensible markup |
| | | language |
| | Internet Communication | Internet Communication |
| | Authoring Tools | Network publication |
| | | tools |
| | Search Engines | Search Engines |
| | Explorer Components | Explorer Components |
| | Others | others |
| Database | Database Connectivity Components | Database Connectivity |
| | | Tools |
| | Database Management | Database Management |
| | Database Reporting | Database Reporting |
| | Data Storage Components | Data Storage |
| | SQL Components | SQL Components |
| | OLAP Components | OLAP Components |
| | Others | others |
| Miscellaneous | Addressing, Postcode/ZipCode | Addressing, Postcode/ |
| | Components | ZipCode Components |
| | Barcode Components | Barcode |
| | Credit Card Authorization Components | Credit card authorization |
| | Telephony Components | Telephony Components |
| | Paging Components | Paging Components |
| | SMS Components | Short messages |
| | Others | others |

Resource location information: This part indicates the storage locations of components; and the component location information in the present embodiment is indicated by URL.

Component Interface information: in the present invention, the component interface information is classified into two classes: provided interface and required interface. The provided interface is specified by its name, literal description, operation list, occurred events, and properties presented to the external. Each operation is further described by its name, literal description, parameters of the operation, a set of pre-conditions, a set of post-conditions, and invariants. Events and properties are depicted in similar ways. Component's required interface also called contect dependencies, referring to the context of component running and composition. It can be specified on two levels: the upper is component level, explicitly indicating the components used by this component; the lower of service level, specifying the component's needs in terms of operations, events, and their corresponding semantics.

In order to satisfy the requirements for the component description being independent of specific component techniques and being extensible, in the present invention, the eXtensible Markup Language (XML) is chosen to represent the descriptors in the UCDL encapsulation structure. XML is a structural information description language independent of platform, and recently is the most popular data description format in the Web. Each description entry in the UCDL encapsulation structure may be expressed by defining a corresponding XML label, thus the description of each component becomes an XML file, and the operations of searching and accessing components can be converted as read/write and retrieval processing of the XML file.

Sub-Step 2 of the Component Encapsulation Method:

Firstly, the type of the component is determined before generating of the encapsulated component. Based on the extension name and the internal identification field of the component file, it is determined whether the type of the component to be encapsulated, for example it is a JavaBean component, an ActiveX component, or other types of components.

Sub-Step 3 of the Component Encapsulation Method:

After the determination of the component type, the information on the component per se is converted into the uniform format defined by the UCDL encapsulation structure by the corresponding mapping method, and those descriptors are filled into corresponding portions of the encapsulation structure to form an encapsulated component which describes the information on the component per se in an unified form.

In the present invention, a JavaBean-to-UCDL mapping method (JUMA) is proposed for the JavaBean components; and an ActiveX-to-UCDL mapping method (AUMA) is also proposed for the ActiveX components. The generation of the UCDL encapsulated components for other types of components may be educed based on the above-mentioned mapping methods.

If the component type is determined to be the JavaBean component, then the mapping method adopted in this invention includes the following steps:
(1) According to the UCDL structure, generating an empty XML file with all empty descriptors, and making preparations for filling component information.
(2) Allocating a unique ID and fill it into the “id” element of the component package as the overall identification of component package.
(3) Then, reading the “Bean information” class of the JavaBean component; it is defined by the JavaBean component specification.
(4) According to the structure of Bean information defined in the JavaBean component specification, obtaining the Name, Author, Vendor, Version, Date, and Size of the component and fill these into the corresponding descriptors in the basic information part of the UCDL package.
(5) Filling the descriptor Functional Description, of the Description field information in the Bean information class into the corresponding elements in the basic information part of UCDL.
(6) Using the existing natural language processing module to retrieve and analyze the Description in Bean information through keywords extraction, and filling the results of Application Field and Component Function into the basic information of the UCDL package.
(7) Filling the Component Model description of the UCDL package with “JavaBean”, and Program Language “Java”.
(8) Starting the self-check mechanism of JavaBean, and getting event and method of the component.
(9) Filling the corresponding descriptor in property information of JavaBean into the property description part of interface information offered by the UCDL package.
(10) Filling the corresponding descriptor in event information of JavaBean into the event description part of interface information offered by the UCDL package.
(11) Filling the corresponding descriptor in method information of JavaBean into the method description part of interface information offered by the UCDL package.
(12) Traversing all the fields of UCDL, leaving the empty fields as defaults.
(13) According to the storage location information of the JavaBean component, filling the location description value of the component to point to the URL of the component.

If the component type is judged to be the ActiveX component, then the mapping method that the invention adopted includes the following steps.
(1) According to the UCDL structure, generating an empty XML file with all empty descriptors, making preparations for filling component information.
(2) Allocating a unique ID and fill it into the “ID” element of the component package, and making it the overall identification of the component package.
(3) According to the component standard and the basic information field of ActiveX field, obtaining the Name, Author, Vendor, Version, Date, and Size of the component and fill them into the basic information part of the UCDL package.
(4) Using the natural language processing module to retrieve and analyze the Type library in ActiveX control through keywords extraction, and fill the results of Application Field and Component Function into the basic information part of the UCDL package.
(5) Filling the Interfaces information of ActiveX into the interface information of UCDL.
(6) Traversing all the fields of UCDL and leaving the empty fields as defaults.
(7) According to the storage location information of the ActiveX component, filling the location descriptor of the packaging component to point to the URL of the component.

After the completion of the above steps, the UCDL encapsulated components in the form of XML file form are stored.

Sub-Step 4 of the Component Encapsulation Method:

Registering encapsulated components to the component directory library, that is, not only the contents of encapsulated components are stored into the component directory library, but also the components are organized, classified and indexed according to the classification information in the encapsulated components to form a hierarchical index structure.

In the present invention, the self-defined component directory service protocol (CDSP) is chosen to accomplish the interaction between component register and the component directory library and implement the registration, cancellation, modification, retrieval and other operations.

The specific form of a message object in the CDSP protocol is as follows:

```
CDSP Message =”(” MessageType MessageParameter* ”)”
MessageType = ”Register”
        |”DeRegister”
        |”Modify”
        |”Search”
MessageParameter = ”:sender” Expression
            | ”:receiver” Expression
            | ”:content” Expression
              | ”:reply-with” Expression
              | ”:in-reply-to” Expression
              | ”:language” Expression
              | ”:ontology” Expression
```

```
<Expression> [symbol]   <word> |<quotation> | <string> | (<word>
                  {<whitespace> <expression>} *)
            <word> [symbol]   <character><character>*
            <character> [symbol]   <alphabetic>|<numeric>|<special>
            <special> [symbol]  <|>|=|+|−|*|/|&|\hat{ }|˜|_|@|$|%|:|.|!|?
            <quotation> [symbol]   ‘<expr>|‘<comma-expr>
            <comma-expr> [symbol]   <word>|<quotation>|<string>|,
                  <comma-expr>|(<word> {<white space><comma-
                  expr>}*)
            <string> [symbol]  “<string char>*)|#<digit><didit>*”<ascii>*
            <string char> [symbol]  \<ascii>|<ascii>-\-<double-quote>
```

The meanings of message parameters in the CDSP message are illustrated in Table 4.

TABLE 4

| Message Parameter | Meaning |
|---|---|
| :sender | The sender of the identification message |
| :receiver | The receiver of the message |
| :content | The content of the message, may contain |
| | JavaBean locator, component descriptor and |
| | etc., the content is determined by the type of the |
| | message. |
| :reply-with | The reply flag to this message |
| :in-reply-to | The reply flag to previous message (similar |
| | to :reply-with value of the previous message) |
| :language | The cording language of the contents of the |
| | message |
| :ontology | indicating the application field to help the |
| | understanding of the content of the message |
| :from | Identifying the initial sender of a forwarded |
| | message |
| :to | Identifying the destination receiver of a |
| | forwarded message |

The registration process is as follows:

When an encapsulated component is registered to the directory library, first, the content of the encapsulated component is filled into the content field of the CDSP message packet, the message type field is marked as “Register”, the message sender field is marked as the register party of the encapsulated component, and the message receiver field is marked as “component directory library”. Then the CDSP message packet is sent to the directory library by an existing transfer protocol (e.g. HTTP, TCP/IP).

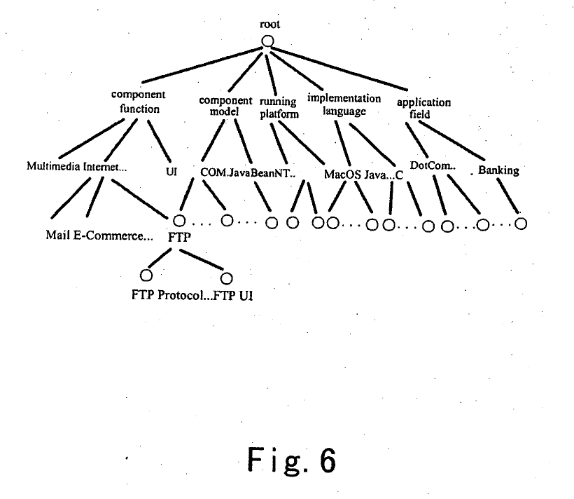

After the directory library receives the CDSP message packet indicating the registration of an encapsulated component, first, acknowledgement response information is sent, then the encapsulated component is read from the content field of the CDSP message packet. After the encapsulated component is read, the content of the encapsulated component is stored into a database to form a class of the component directory library and acquire a unit-directory registration entry. At the same time, index value of the encapsulated component is generated based on the five viewpoints of classification information on the encapsulated component, and is added into the index directory of the directory library, which is a tree directory structure organized according to the set of terms in the classification information in the structure of the encapsulated component, as shown in FIG. 6.

The leaf nodes of the lowest layer in a directory tree (the circles in the figure) correspond to components, and the non-leaf-node represents a group of components having the same classification property. The five component classification information portions, i.e., component functions, component models, operating systems, programming languages and application fields of the classification information in a UCDL encapsulation structure correspond, respectively, to five sub-trees under the root of the directory tree. As viewed from the five pieces of classification information, each of the branches represents a term in the basic term set of this classification, wherein there are further sub-trees of sub-classification directory corresponding to the sub-trees of the component function directory. The index of the encapsulated component is mapped onto the leaf node based on the classification information in the encapsulated component (at the beginning of searching a component by the application party, a great majority of the searches start the search with a query of the classification information of the component, therefore, such an index directory structure can be helpful for the component application party to quickly search and find the components satisfying the conditions based on the classification information of the required component, and the search range can be further reduced to achieve the objects of improving search efficiency and reducing cost).

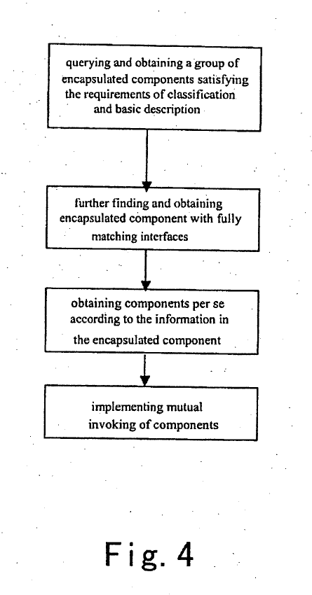

The step 4 of the unified access method of components having the above mentioned encapsulation structure comprises following sub-steps as shown in FIG. 4:
1. First, a component user queries and obtains a set of encapsulated components required for performing the required functions based on the component classification information and basic description information in the encapsulation structure.
2. Encapsulated component of fully matching interfaces are further found based on the interface information in the UCDL encapsulation structure.
3. The components per se are acquired from the component library according to the location information in the encapsulated component.
4. Between the components and the component user, by the use of the interface information descriptor defined in the UCDL encapsulated component in combination with the component binding protocol (e.g., SOAP: Simple Object Access Protocol), the mutual invoking between components is implemented. The procedure for implementing mutual invoking between components by the use of the SOAP protocol and the UCDL encapsulation structure according to an embodiment of the present invention is as follows: first, the component user sends a SOAP request to perform initialization. In this procedure, a valid SOAP request is packeted based on the interface descriptor in the UCDL encapsulated component, and this SOAP request is submitted to a component running environment, then the SOAP is interpreted and executed and the component per se is invoked by the component running environment, by the use of corresponding component invoking method, based on different component types. After the invoking of components, the returned results of the invoking are packeted according to the return value information on the operation descriptor defined in the UCDL encapsulated component, and returned in the format of SOAP packets. The user can obtain the results of the invoking by opening the SOAP return information packet, then the full component invoking procedure ends.

What is claimed is:

1. An encapsulation and unified access method for components, comprising the steps of:
1) configurating component warehouse on one or more computers, and storing components obtained from the Internet into the component warehouse to form a component warehouse computer;
2) configurating a component directory library on another computer to form a component directory library computer;
3) fetching component from the component warehouse computer by a user computer, encapsulating the component to form a encapsulated component, and organizing and storing the encapsulated component in the component directory library computer; and
4) performing unified access to component resources by a user computer based on the component encapsulation information in the component directory library computer.

2. The method according to claim 1, wherein said encapsulating component comprises the sub-steps of:
1) constructing a general component encapsulation structure, the encapsulation structure being divided into a static part and a dynamic part described in unified forms, wherein the static part comprises basic description information, resource location information, and classification information on the component; and the dynamic part is component interface information, and comprises provided interface and required interface by the running of the component;
2) fetching a component from the existing component warehouse, and determining the type of the component to be encapsulated based on its file extension name and its internal identification field of the component;
3) Choosing corresponding conversion method aiming to different types of components, converting the information of the component to a uniform format, and filling them in the UCDL encapsulation structure, to form a encapsulated component described in unified form; and
4) registering the encapsulated component to the directory library;
wherein the encapsulated component formed in step 3) is organized into the component directory library according to the classification information; a general index structure is created for all the encapsulated components in the component directory library according to the classification information on the components; each of the directory entries in the component directory library is an encapsulated component; and the component per se is still stored in the original component warehouse.

3. The method according to claim 1, wherein said performing unified access to the component comprises the sub-steps of:
(1) according to the classification information and basic description information in the encapsulated components, inquiring a group of encapsulated components conforming to the conditions from the indexing structure of the directory library;
(2) according to the interface information in the encapsulated component, finding an encapsulated component with a fully matched interface;
(3) fetching the required component entity per se from the component library based on the location information in the encapsulated component;
(4) between a component user and the component entity, by the use of interface information descriptors defined in the UCDL encapsulated component, in combination with the existing component binding protocol (e.g. SOAP: Simple Object Access Protocol), realizing mutual invoking between components.

4. A method for collecting, encapsulating and accessing components on a network, comprising the steps of:
searching components on the network based on component identifications, and storing the searched components into a component warehouse to form a component warehouse computer;
constructing a general encapsulation structure for types of components in the warehouse, wherein the encapsulation structure comprises a static part and a dynamic part described in a unified form; the static part includes basic description information, resource location information and classification information on the component, and the dynamic part includes provided interface and required interface for running of the component;
fetching a component from the existing component warehouse, and forming classification information on the component to be encapsulated based on a file extension name and an internal identification field of the component;
fetching the information of the component per se and its location information in the component warehouse, and filling the information into corresponding portions of the encapsulation structure according to corresponding format and based on corresponding mapping scheme, i.e., instancing the encapsulated component;
for each encapsulated component, registering it into the component directory library according to the information of the classification information portion in the encapsulated component, wherein the component directory library maintains a general index structure, and all the registered encapsulated component are indexed;
issuing the index structure in the component directory library and corresponding searching tools on the network;
searching the index structure of the directory library by the component user's input of classification information and description information, and obtaining a group of encapsulated components conforming to the searching information;
further finding the encapsulated components with interface information fully matching the required interface by the component user, from the group of encapsulated components as the result of the searching; and
obtaining the components corresponding to the encapsulated components from the component library, based on the location information in the found encapsulated components, or invoking the component.

5. The method according to claim 4, wherein the network is the Internet, and the description information associated with the component is stored together with the component during the searching for the component.

6. The method according to claim 5, further comprising: manually modifying the instanced encapsulated components and their registration information in the component directory library by the administrator of the component library, with reference to the description information associated with the component.

7. The method according to claim 6, wherein said encapsulation structure is a component information description file in the form of XML file.

8. The method according to claim 7, wherein the required components are invoked by the use of component binding protocol.

9. The method according to claim 8, wherein said component classification information is formed by a component model, an application field, a programming language, an operating system and component functions.

10. The method according to claim 9, wherein the component functions are further subdivided into classes of development tools, file processing, multimedia, network tools, scientific computing, user interface, word processing, Internet/Enterprise Intranet, database, miscellaneous and etc.

11. A system for implementing unified access to component resources, comprising:
one or more component libraries for storing components acquired from a network;
a component directory library for storing the directory of said components; and
user terminals for fetching a component from said component library, encapsulating the component to form an encapsulated component, and organizing and storing the encapsulated component into said component directory library; wherein said user terminals perform unified access to the component resources based on the information on the encapsulated component in said component directory library.

12. A method for encapsulating a component, comprising the steps of:
1) constructing a general component encapsulation structure;
2) fetching a component from existing component libraries, and determining the type of the component to be encapsulated based on the file extension name and the internal identification field of the component;
3) with respect to different types of components, fetching information on the component per se, converting the information on the component per se by the use of corresponding mapping method, and filling the converted information into corresponding portions of the encapsulation structure, to form encapsulated components described in an unified form.

13. The method according to claim 12, further comprising:
registering the encapsulated component to a component directory library;
wherein the encapsulated component formed in step 3) is organized into the component directory library according to the classification information library; a general index structure is created for all the encapsulated components in the component directory library according to the classification information of the components; each of the directory entries in the component directory library is the encapsulated component; and the component per se is still stored in the original component library.

14. The method according to claim 12, wherein,
the encapsulation structure contains a static component information part and a dynamic component information part described in an unified form; the static component information part includes basic description information, resource location information and classification information on the component, and the dynamic component information part is interface information on the component, including interface information provided by the component and interface information required by the running of the component.

15. A method of implementing unified access to a component library, wherein the components in the component library have a general encapsulation structure, which contains a static component information part and a dynamic component information part; the static component information part includes basic description information, resource location information and classification information on the component; the dynamic component information part is interface information on the component and includes interface information provided by the component and interface information required by the running of the component;
said method comprising:
according to the classification information and basic description information in the encapsulated component, inquiring a group of encapsulated components conforming to the conditions from the indexing structure of the directory library by a component user;
according to the interface information in the encapsulated component, finding an encapsulated component with a fully matched interface;
fetching the required component per se from the component library based on the location information in the encapsulated component;
between a component user and the component, by the use of interface information descriptors defined in the UCDL encapsulated component, in combination with the existing component binding protocol, realizing mutual invoking between components.

16. A computer program product that stores instruction for causing a computer to execute a method of implementing unified access to component resources, comprising the steps of:
constructing a general component encapsulation structure;
fetching a component from existing component libraries, and determining the type of the component to be encapsulated based on the file extension name and the internal identification field of the component;
with respect to different types of components, fetching information on the component per se, converting the information on the component per se by the use of corresponding mapping method, and filling the converted information into corresponding portions of the encapsulation structure, to form encapsulated components described in an unified form;
according to the classification information and basic description information in the encapsulated component, inquiring a group of encapsulated components conforming to the conditions from the indexing structure of the directory library by a component user;
according to the interface information in the encapsulated component, finding an encapsulated component with a fully matched interface;
fetching the required component per se from the component library based on the location information in the encapsulated component;
between a component user and the component, by the use of interface information descriptors defined in the UCDL encapsulated component, in combination with the existing component binding protocol, realizing mutual invoking between components.
